(19) United States
(12) Patent Application Publication
(10) Pub. No.: US 2026/0034001 A1
(43) Pub. Date: Feb. 5, 2026

(54) CHILDREN'S MEDICAL CART WITH SEAT

(71) Applicant: Imami Toys (Hebei) Co., Ltd., Handan (CN)

(72) Inventor: Shuyong LUO, Handan (CN)

(73) Assignee: Imami Toys (Hebei) Co., Ltd., Handan (CN)

(21) Appl. No.: 19/017,776

(22) Filed: Jan. 13, 2025

(30) Foreign Application Priority Data
Jul. 31, 2024 (CN) 2024218359431

(51) Int. Cl. A61G 5/08; A61G 12/00; B62B 7/06; B62B 9/10

(52) U.S. Cl. CPC A61G 5/08; A61G 12/008; B62B 7/062; B62B 9/108

(57) ABSTRACT

The present disclosure relates to a children's medical cart with a seat, comprising a cart body and a seat arranged on the cart body. The seat comprises a seat pan and a back pan and the seat pan is hinged with the back pan. The seat has a first state folded and a second state unfolded, a connecting part is arranged on the back pan, both sides along the length direction of the cart body are provided with a connection fitting part, the connecting part is connected with the connection fitting part, the seat is installed on the cart body. The seat pan is provided with a plug-in part, and both sides along the length direction of the cart body are provided with a plug-in fitting part. In the second state, the plug-in part is inserted into the plug-in fitting part to limit the seat pan on the cart body.

### CROSS-REFERENCE TO RELATED APPLICATIONS

The application claims priority to Chinese patent application No. 2024218359431, filed on Jul. 31, 2024, the entire contents of which are incorporated herein by reference.

### TECHNICAL FIELD

The present disclosure relates to the technical field of medical carts, in particular to a children's medical cart with a seat allowing convenient storage.

### BACKGROUND

At present, for most of the existing children's medical carts on the market, seats are fixed in the design. Although this design has a simple structure, in practical application, because the seat is non-foldable, the medical cart occupies a large space when not in use, especially in medical institutions where space resources are precious and the fixed seat design is not conducive to efficient use of space. Moreover, the fixed seat cannot be adjusted according to different body sizes and treatment needs of children, which may affect the comfort and safety of children, especially in case of long-term use or special treatment.

Recently attempted improvements include the introduction of carts with detachable seats, such as a cart with seats with Publication No. CN216886856U, which has an unfolded state and a folded state, comprising a frame structure composed of a front frame, a rear frame, a bottom frame and two side frames. Both ends of the side frames are respectively provided with upper and lower two-folding bars hinged to the front frame and the rear frame, and a detachable seat is arranged in the frame structure. The seat on the cart comprises a backrest and a cushion with an integrated design, and there is a gap between the cushion and the underframe. The seat in the cart is connected with the frame structure by hanging. In a loading state, the cart can carry children with the seat and reserve a certain cavity for carrying articles. If the seat is removed, the amount of articles loaded on the cart can be increased. The patent document discloses a cart with a seat. Although this design allows the seat to be disassembled to increase the space for loading articles, the seat is of an integrated structure and fixed on the cart by hanging on both sides, which may reduce stability and safety when carrying a certain weight. Moreover, this structural design cannot play a good securing role for children on the seat and is not suitable for younger children. In addition, the cart with Publication No. CN110356448A specifically discloses an expansion system of the cart, which comprises a frame composed of two side frames in folded and unfolded states, wherein the expansion system comprises an expansion seat for installing the expansion device and a supporting rod, the expansion system connects the expansion unit to the frame through the expansion seat, and at the same time, the expansion unit is also detachably connected with the frame. In the scenario where the expansion system is not required, the expansion system does not affect the use of the cart; when it is necessary to use the expansion unit, the expansion system can be quickly assembled. The technical solution disclosed in the above-mentioned application is neat after folding and easy to carry; it has a large space and stable structure when being unfolded. However, this structural design will make a child sit on a high position, raise the center of gravity of the whole trailer, which is not conducive to the overall stability of the trailer. In addition, in the above two solutions, when the cart is stored, the seat can only be taken out and stored separately, and the whole cart is not convenient to carry and store.

To overcome these limitations, a novel design is needed to improve the utility, safety and convenience of children's medical carts.

### SUMMARY

The purpose of the present disclosure is to propose a children's medical cart with a seat that can be quickly folded and unfolded while ensuring stability and safety during use, so as to meet the specific needs of children's medical environment.

In order to achieve the above purpose, the technical solution proposed in the present disclosure is as follows: a children's medical cart with a seat is provided. The cart comprises a cart body and a seat arranged on the cart body;
wherein the seat comprises a seat pan and a back pan, the seat pan is hinged with the back pan; the seat has a first state folded and a second state unfolded; in the first state, the seat pan is parallel to the back pan, and in the second state, the seat pan and the back pan are turned over at a certain angle;
the back pan is provided with a connecting part for connecting with the cart body, and both sides along a length direction of the cart body are each provided with a connection fitting part for connecting with the seat; the connecting part is connected with one of the connection fitting parts so as to mount the seat on the cart body; and
the seat pan is provided with a plug-in part extending along one of its sides facing the back pan, and both sides along the length direction of the cart body are each provided with a plug-in fitting part corresponding to the plug-in part; in the second state, the plug-in part is inserted into one of the plug-in fitting parts so as to limit the seat pan on the cart body.

The present disclosure relates to a children's medical cart with a seat, by designing the foldable seat which is composed of a seat pan and a back pan and these two parts are hinged with each other, which means that the seat can be switched between a first state and a second state: In the folded state, the seat pan is parallel to the back pan, which helps reduce the overall size of the cart and makes it easier to store and transport; in the unfolded state, the seat pan and the back pan are turned over at a certain angle to provide a proper sitting posture support for children. The fast folding and unfolding function of the seat makes it easy for the operator to switch between different usage scenarios.

In addition, the back pan is provided with a special connecting part, and both sides of the cart body are provided with connection fitting parts for connecting with the cart body to ensure that the seat is firmly installed on the cart. The seat pan is further provided with a plug-in part, and when the seat is in an unfolded state, the plug-in part can be inserted into the plug-in fitting part on the cart body, thus further enhancing the connection stability between the seat pan and the cart.

Further, the connection fitting part comprises a supporting rod horizontally arranged on the cart body;
the connecting part comprises a joint bar arranged on the back pan, and the joint bar extends along a height direction of the back pan. The joint bar and the back pan are arranged perpendicular to each other, one side of the joint bar near the back pan is set as a smooth surface, and the other side of the joint bar is provided with a hooking part that is hooked and connected with the supporting rod.

In the present disclosure, by horizontally arranging the supporting rod on the cart body, a stable connection point is provided for the seat, and it can bear the weight of a child without displacement or shaking. The joint bar extends along the height direction of the back pan and is set perpendicular to the back pan, so as to ensure that the joint bar can be closely attached to the cart body when being installed and improve the stability of the seat. The joint bar is provided with a hooking part, and through the hooking connection between the hooking part and the supporting rod, the seat can be firmly installed on the cart, even when moving or turning. The hooking part is designed so that the seat can be quickly connected or separated from the cart body, which facilitates medical staff to respond quickly in case of emergency. This design ensures that the joint bar can be firmly hooked on the supporting rod, further improving the stability of seat installation.

Further, the bottom of the joint bar extends towards the seat pan, and a limiting part is arranged between the joint bar and the seat pan for limiting the rotation angle of the seat pan relative to the joint bar; and
the seat pan is detachably provided with an elastic air cushion.

Further, the limiting part comprises an arc-shaped sliding slot arranged on the joint bar, and a sliding rod arranged on the seat pan; when the sliding rod slides along one end of the arc-shaped sliding slot to another end thereof, the seat is switched from the first state to the second state.

Further, the plug-in part comprises an inserting rod arranged on the seat; the inserting rod extends towards the direction of the back pan, and a groove is arranged at an end of the back pan;
the plug-in fitting part comprises a plug post arranged on the cart body; in the second state, the plug post abuts in the groove to limit the seat pan on the cart body.

The combination of the arc-shaped sliding slot and the sliding rod in the present disclosure ensures that the rotation angle of the seat pan relative to the back pan is accurately controlled, so that the seat can move smoothly during folding and unfolding, avoiding sudden overturn or jamming. The plug-in fitting part comprises a plug post arranged on the cart body. When the seat is in an unfolded state, the plug post abuts in the groove to limit the seat pan on the cart body. The design of the plug post makes the connection between the seat and the cart body more firm, avoiding accidental movement of the seat during use, ensuring the stability and safety of the seat in an unfolded state, and simplifying the installation and removal process between the seat and the cart body, with user experience and operation convenience improved. Moreover, setting an air cushion on the seat pan is conducive to improving the comfort of children.

Further, the cart body comprises a first U-shaped frame and a second U-shaped frame arranged symmetrically along a width direction of the cart, and a third U-shaped frame arranged between the first U-shaped frame and the second U-shaped frame; a push rod is hingedly arranged between two top ends of the first U-shaped frame and the second U-shaped frame, wheels are arranged at a bottom of two folding corners of the first U-shaped frame and the second U-shaped frame, two folding corners of the third U-shaped frame are hinged with two folding corners of the first U-shaped frame through two first connecting rods, and two folding corners of the third U-shaped frame are hinged with two folding corners of the second U-shaped frame through two second connecting rods;
the first U-shaped frame comprises two first upright poles symmetrically arranged along a length direction of the cart, and a first cross bar connecting the two first upright poles; the second U-shaped frame comprises two second upright poles symmetrically arranged along a length direction of the cart, and a second cross bar connecting the two second upright poles; the third U-shaped frame comprises two third upright poles symmetrically arranged along a length direction of the cart, and a third cross bar connecting the two third upright poles; and
a top end of the first upright pole is hinged with a bottom end of the second upright pole arranged on the same side along a length direction of the cart through a first folding bar, and a bottom end of the first upright pole is hinged with a top end of the second upright pole arranged on the same side along a length direction of the cart through a second folding bar, and both the first folding bar and the second folding bar are hinged with a top of the third upright pole on the same side.

In the present disclosure, the cart body is designed in such a way that a top end of the first upright pole is hinged with a bottom end of the second upright pole on the same side through the folding bar, a bottom end of the first upright pole is hinged with a top end of the second upright pole on the same side through the folding bar, and both folding bars are hinged with a top of the third upright pole on the same side, thus ensuring that the cart can be compactly folded when it is folded and stable when it is unfolded. Moreover, the present disclosure simplifies the process of folding and unfolding the cart, which improves both user experience and operation convenience.

Further, one of the first upright poles is provided with an inserting hole for placing a transfusion rod, and/or one of the second upright poles is provided with an inserting hole for placing a transfusion rod.

Further, one of the first upright poles is provided with a through hole for mounting an oxygen cylinder erecting bracket, and/or one of the second upright poles is provided with a through hole for mounting an oxygen cylinder erecting bracket.

Further, a first strut for preventing falling is arranged between the first upright pole and the second upright pole, which are arranged on the same side along the length direction of the cart, and a second strut for preventing falling is arranged between the two first upright poles and the two second upright poles.

Further, a plurality of reinforcing rods are arranged between the two connecting rods arranged on the same side along the width direction of the cart.

In the present disclosure, an inserting hole for placing a transfusion rod is provided so that medical staff can conveniently fix the transfusion rod, avoid shaking or dropping of a transfusion bag during transfusion, and enhancing convenience and safety. The present disclosure allows an oxygen cylinder to be mounted safely on a cart for easy access while moving, and it is especially important if rapid patient transfer is required in an emergency. The design of the strut provided for falling prevention prevents articles placed on the cart from accidentally slipping, increasing the safety of the cart during use.

The present disclosure provides a children's medical cart with a seat, which has the following beneficial effects:

Compared with the prior art, the present disclosure provides a children's medical cart with a seat. For the seat, the angle of the seat pan and the back pan can be changed through hinge connection to realize folding and unfolding, so that space can be saved when the cart is not in use and a comfortable seat can be provided when it is in use. The seat is fixed on the cart body through the cooperation between the connecting part and the connection fitting part, which can ensure the stability of the seat on the cart body. Moreover, the setting of a limiting part can ensure that the seat pan is in an appropriate position to avoid excessive rotation and ensure the safety of children.

The connecting part is provided with a joint bar, which has a simple structure and good stability. A hooking part is arranged on one side of the joint bar to be hooked with the cart body to ensure stable connection of the seat on the cart body. Moreover, the limiting part ensures that the seat pan is in an appropriate position to avoid excessive rotation and ensure the safety of children.

The cart is designed with a U-shaped frame, which increases the overall stability and bearing capacity. The configuration of multiple folding bars and connecting rods allows the cart to be folded when necessary for easy storage and transport. The cart is provided with an inserting hole and a through hole for placing a transfusion rod and an oxygen cylinder, as well as struts and reinforcing rods for preventing falling. These designs enhance the functionality and safety of the cart.

### BRIEF DESCRIPTION OF DRAWINGS

To illustrate technical solutions in embodiments of the present disclosure more clearly, accompanying drawings to be used for describing the embodiments or prior art are introduced briefly in the following. Apparently, the accompanying drawings in the following description are only some embodiments of the present disclosure, and persons of ordinary skill in the art can derive other drawings from these accompanying drawings without creative efforts.

FIG. 1 is an overall structural diagram of the children's medical cart with a seat according to an embodiment of the present disclosure;

FIG. 2 is a structural diagram of the cart body according to an embodiment of the present disclosure;

FIG. 3 is a structural diagram of the third U-shaped frame at one side of the cart body according to an embodiment of the present disclosure;

FIG. 4 is a front view of the cart body in the state as shown in FIG. 2;

FIG. 5 is a structural diagram of the seat according to an embodiment of the present disclosure;

FIG. 6 is a bottom view of the seat in the state as shown in FIG. 5;

FIG. 7 is a schematic diagram of the connection relationship between the connecting part and the connection fitting part according to an embodiment of the present disclosure; and

FIG. 8 is a schematic diagram of the connection relationship between the plug-in part and the plug-in fitting part according to an embodiment of the present disclosure.

The reference symbols in the drawing are as follows:
1. cart body; 11. first U-shaped frame; 111. first upright pole; 112. first cross bar; 12. second U-shaped frame; 121. second upright pole; 122. second cross bar; 13. third U-shaped frame; 131. third upright pole; 132. third cross bar; 141. first connecting rod; 142. second connecting rod; 151. first folding bar; 152. second folding bar; 16. supporting rod; 17. plug post; 181. first strut; 182. second strut; 19. reinforcing rod; 110. push rod;
2. seat; 21. back pan; 22. joint bar; 221. hooking part; 222. arc-shaped sliding slot; 23. seat pan; 231. air cushion; 24. connecting bar; 241. sliding rod; 242. pin shaft; 25. inserting rod; 251. groove;
3. first buckle; 31. inserting hole;
4. The second clip; 41. through hole;
5. wheel; 6. transfusion pole; 7. oxygen cylinder mounting bracket.

### DETAILED DESCRIPTION OF THE EMBODIMENTS

In order to make the technical challenges to be addressed, technical solutions and beneficial effects by this embodiment more clear, this embodiment will be further described in detail below with reference to the drawings and embodiments. It should be understood that the specific embodiments described herein are only for explaining this embodiment and not for limiting the same.

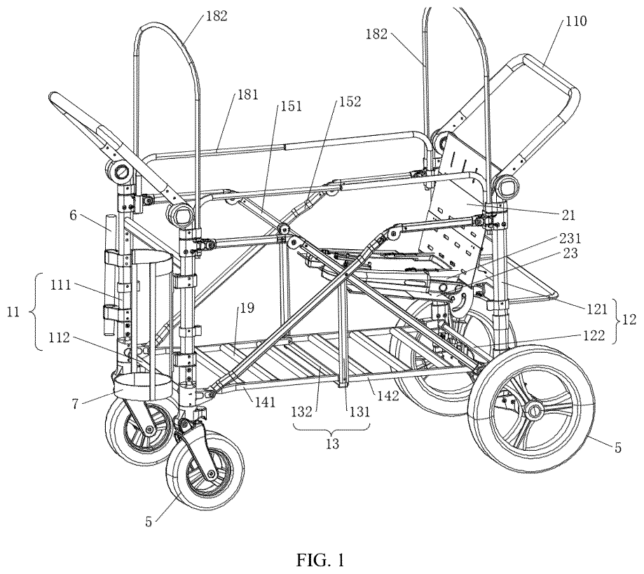

Referring to FIG. 1 through FIG. 8, a children's medical cart with a seat proposed in this embodiment will now be described. The children's medical cart with a seat according to this embodiment comprises a cart body 1 and a seat 2 arranged on the cart body 1.

In which, the seat 2 comprises a seat pan 23 and a back pan 21. The seat pan 23 is hinged with the back pan 21. The seat 2 has a first state folded and a second state unfolded. In the first state, the seat pan 23 is parallel to the back pan 21; in the second state, the seat pan 23 and the back pan 21 are turned over at a certain angle.

In addition, the back pan 21 is provided with a connecting part for connecting with the cart body 1, and both sides along a length direction of the cart body 1 are provided with a connection fitting part for connecting with the seat 2; the connecting part is connected with one of the connection fitting parts so as to mount the seat 2 on the cart body 1; and
in addition, the seat pan 23 is provided with a plug-in part extending along one of its sides facing the back pan 21, and both sides along the length direction of the cart body 1 are each provided with a plug-in fitting part corresponding to the plug-in part; in the second state, the plug-in part is inserted into one of the plug-in fitting parts so as to limit the seat pan 23 on the cart body 1.

This embodiment provides a children's medical cart with a seat. For the seat 2, the angle of the seat pan 23 and the back pan 21 can be changed through hinge connection to realize folding and unfolding, so that space can be saved when the cart is not in use and a comfortable seat can be provided when it is in use. The seat 2 is fixed on the cart body 1 through the cooperation between the connecting part and the connection fitting part, which can ensure the stability of the seat 2 on the cart body 1. Moreover, the setting of a limiting part can ensure that the seat pan 23 is in an appropriate position to avoid excessive rotation and ensure the safety of children.

In a word, the present disclosure addresses challenges of the traditional children's medical carts such as large space occupation, poor adaptability, insufficient stability, poor safety, portability and storage inconvenience by introducing a foldable seat 2 design and strengthening the connection mode between the seat 2 and the cart body 1, thus improving the overall practicability and convenience of the cart.

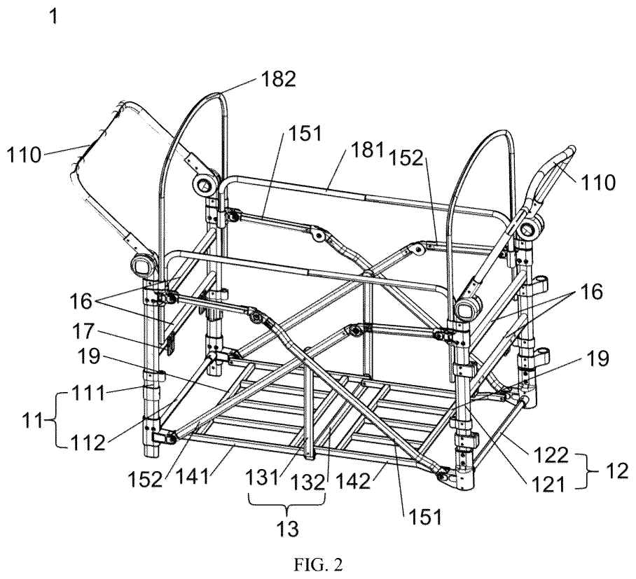

Based on the above overall description of the structure, an exemplary structure of the children's medical cart with a seat according to this embodiment is as shown in FIGS. 1 and 2. The cart body 1 comprises a first U-shaped frame 11 and a second U-shaped frame 12 symmetrically arranged along a width direction of the cart, and a third U-shaped frame 13 arranged between the first U-shaped frame 11 and the second U-shaped frame 12. Wheels 5 are arranged at two folding corners of the first U-shaped frame 11 and the second U-shaped frame 12, push rods 110 are hingedly arranged between two top ends of the first U-shaped frame 11 and the second U-shaped frame 12, and two folding corners of the third U-shaped frame 13 are hinged with two folding corners of the first U-shaped frame 11 through two first connecting rods 141 respectively. The two folding corners of the third U-shaped frame 13 are respectively hinged with the two folding corners of the second U-shaped frame 12 through two second connecting rods 142.

Referring to FIGS. 1 and 2, the first U-shaped frame 11 comprises two first upright poles 111 symmetrically arranged along a length direction of the cart, and a first cross bar 112 connecting the two first upright poles 111; the second U-shaped frame 12 comprises two second upright poles 121 symmetrically arranged along a length direction of the cart, and a second cross bar 122 connecting the two second upright poles 121; the third U-shaped frame 13 comprises two third upright poles 131 symmetrically arranged along a length direction of the cart, and a third cross bar 132 connecting the two third upright poles 131.

In which, the first U-shaped frame 11 and the third U-shaped frame 13 are symmetrically arranged along a left-right direction, and a spacing between them constitutes a length of the cart; a spacing between two first upright poles 111 or a spacing between two second upright poles 121 constitutes a width of the cart. In order to ensure the stability of the cart structure, the spacing between two first upright poles 111 and the spacing between two second upright poles 121 are preferably kept equal. The third U-shaped frame 13 is arranged at an intermediate position between the first U-shaped frame 11 and the second U-shaped frame 12.

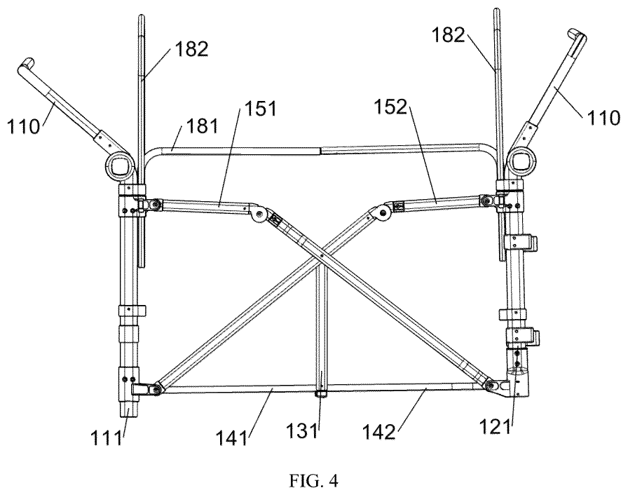

In addition, the side structure of the cart body 1 in this embodiment is shown in FIG. 4. A top end of the first upright pole 111 is hinged with a bottom end of the second upright pole 121 arranged on the same side along a length direction of the cart through a first folding bar 151, and a bottom end of the first upright pole 111 is hinged with a top end of the second upright pole 121 arranged on the same side along a length direction of the cart through a second folding bar 152, and both the first folding bar 151 and the second folding bar 152 are hinged with a top of the third upright pole 131 on the same side. The structures of the first folding bar 151 and the second folding bar 152 are two straight bars hinged at one end as shown in FIG. 4. For details, reference may be made to a common structure of two-folding pull rods in the prior art, which is not described in detail herein.

In order to further reinforce the bottom structure of the cart, preferably, a plurality of reinforcing rods 19 are respectively arranged between two first connecting rods 141 and two second connecting rods 142 arranged on the same side along the width direction of the cart. The two ends of the reinforcing rod 19 are connected with the connecting rods on the front and rear sides at the same time, so as to enhance the stability of the bottom of the cart. On this basis, a reinforcing rod 19 horizontal to the connecting rod can also be added, which can be designed and processed according to actual requirements.

In this embodiment, preferably, all parts of the structure on the cart body 1, such as the first U-shaped frame 11, the second U-shaped frame 12, the third U-shaped frame 13, the first connecting rod 141, the second connecting rod 142, the first folding bar 151, the second folding bar 152 and the supporting rod 16 are made of aluminum plates, so that the overall weight of the cart can be reduced while maintaining the structural stability. It can be understood that other structures with the same or similar characteristics and materials may also be used, which is not limited thereto.

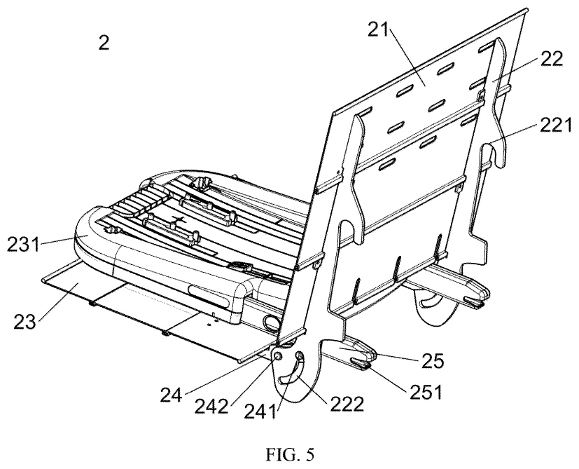

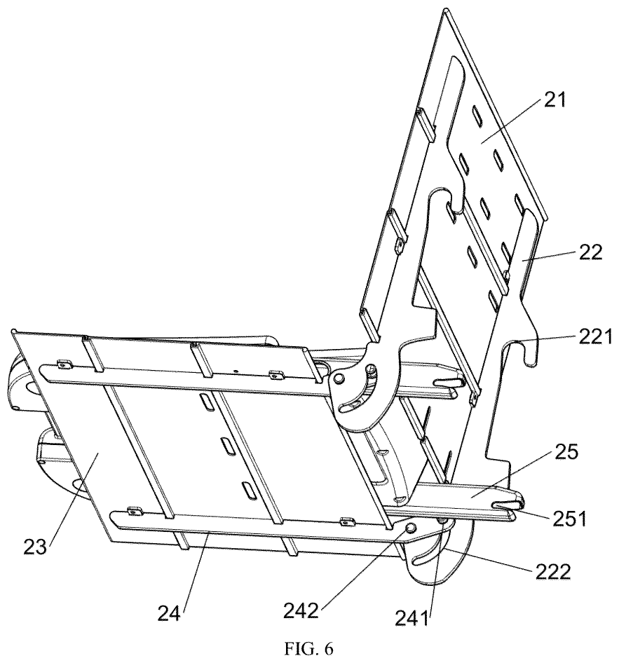

Moreover, referring to FIGS. 5 and 6, the seat 2 in this embodiment includes a seat pan 23 and a back pan 21, and the seat 2 is connected with the aforementioned first U-shaped frame 11 or the aforementioned second U-shaped frame 12 through the back pan 21 along the length direction of the cart.

As a preferred embodiment, the above-mentioned connection fitting part is a supporting rod 16 horizontally arranged in the width direction of the cart body 1. Referring to FIGS. 1 to 3, both ends of the supporting rod 16 are respectively connected with two first upright poles 111, or both ends of the supporting rod 16 are respectively connected with two second upright poles 121, or one supporting rod 16 is connected between the two first upright poles 111 and the two second upright poles 121. It can be set according to actual needs.

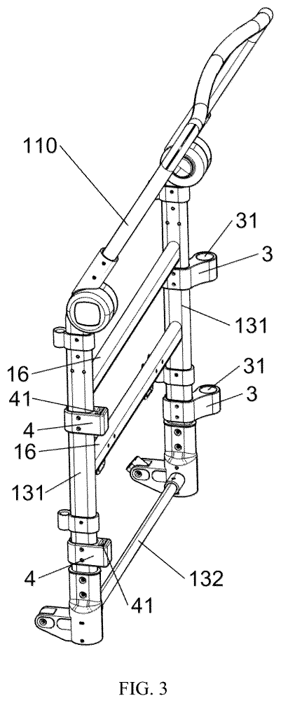

In order to improve the stability of the cart structure, referring to FIG. 3, two supporting rods 16 are connected between the two first upright poles 111 and the two second upright poles 121 along the height direction of the cart. It can be understood that the number of the supporting rods 16 is not limited to be two, but more supporting rods 16 may further be configured.

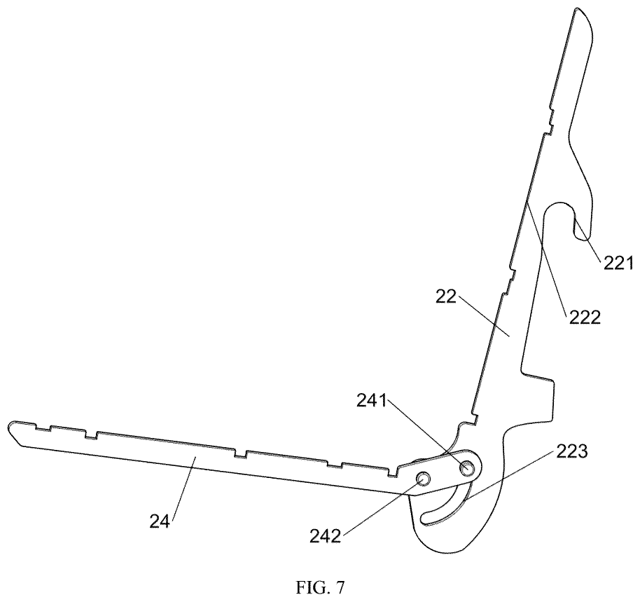

In this embodiment, preferably, as shown in FIG. 5, FIG. 6 and FIG. 7, the above-mentioned connecting part is a joint bar 22 arranged on the back pan 21 and the joint bar 22 extends along a height direction of the back pan 21. The joint bar 22 and the back pan 21 are arranged perpendicular to each other, one side of the joint bar 22 is fixedly connected with the back pan 21 and the other side is provided with a hooking part 221, and the hooking part 221 is hooked with the supporting rod 16. Preferably, two joint bars 22 are provided along the width direction of the back pan 21 to improve stability in connection with the supporting rod 16. Here, one of the joint bars 22 is taken as an example for description. One side of the joint bar 22 is provided with a smooth surface to facilitate attachment and connection with the back pan 21, and the other side of the joint bar 22 is provided with a hooking groove, so that the seat 2 can be placed on the cart body 1 by hanging the hooking groove onto the supporting rod 16 above.

As a further improvement, in this embodiment, the lower end of the aforementioned joint bar 22 extends towards the seat pan 23 and limits the rotation angle of the seat pan 23 relative to the joint bar 22. As a specific preferred embodiment, as shown in FIG. 5 to FIG. 7, the limiting part comprises an arc-shaped sliding slot 222 arranged on the joint bar 22 and a sliding rod 241 arranged on the seat pan 23. When the sliding rod 241 slides along the lower end of the arc-shaped sliding slot 222 to the other upper end, the seat 2 is switched from the first state to the second state.

In this embodiment, the seat pan 23 is detachably provided with an elastic air cushion 231. With specific reference to FIG. 6, the bottom of the seat pan 23 is provided with connecting bars 24 corresponding to the two joint bars 22 respectively, and an air cushion 231 convenient for a child to sit on is disposed on the connecting bars 24 to improve comfort during riding. In which, the structure of the air cushion 23 1 may refer to that of the air cushion 231 of a vehicle's seat 2 in the prior art, and will not be described in detail herein. In which, the air cushion 231 is also suitable for being connected with a child seat in an automobile, and has certain universality. In addition, the connecting bar 24 is arranged along a length direction of the seat pan 23, and one end of the connecting bar 24 extends towards one side of the back pan 21. The extending parts of the connecting bar 24 and the joint bar 22 are connected together by a pin shaft 242, so as to realize the hinged connection between the seat pan 23 and the back pan 21. It is worth noting that, in this embodiment, the positions between the connecting bar 24 and the seat pan 23, as well as between the joint bar 22 and the back pan 21 are limited by a clamping block structure, and screws are arranged for fixed connection at the same time, which can help improve the stability of the connection. Of course, other limiting and fixing forms may also be configured, which are not specifically limited herein.

Moreover, in order to facilitate the rotation of the seat pan 23 relative to the back pan 21, as shown in FIG. 6, an arc-shaped sliding slot 222 is provided on the joint bar 22 corresponding to the rotating track of the seat pan 23, and a sliding rod 241 is provided on the connecting bar 24. When the seat pan 23 rotates relative to the back pan 21, the sliding rod 241 slides in the arc-shaped sliding slot 222 so as to avoid interference with the sliding movement of the seat pan 23 and further enhance the connection stability between the seat pan 23 and the back pan 21.

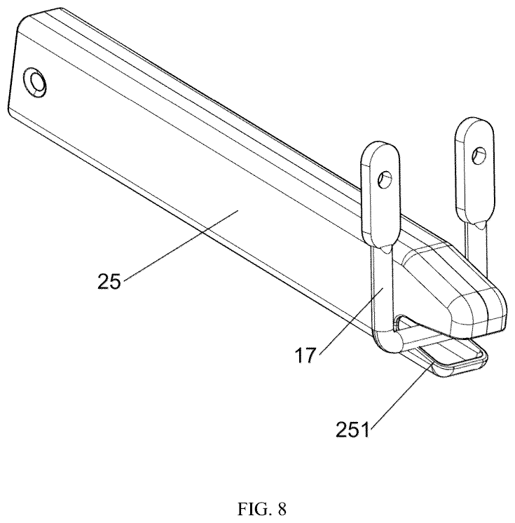

As a further improvement of this embodiment, when the seat 2 is in the unfolded second state, in order to ensure the stability of the seat pan 23, the seat 2 is limited on the cart body 1 by using the cooperation between the plug-in part and the plug-in fitting part, so as to enhance stabilization of the seat 2. As a preferred embodiment, as shown in FIGS. 5 and 8, the plug-in part comprises an inserting rod 25 arranged on the seat 2, the inserting rod 25 extends towards the back pan 21, and one end of the inserting rod 25 close to the back pan 21 is provided with a groove 251. The plug-in fitting part includes a plug post 17 arranged on the cart body 1. In the second state, the plug post 17 abuts in the groove 251 to clamp the seat pan 23 on the cart body 1.

Specifically referring to FIGS. 1, 2 and 7, the supporting rods 16 arranged on the first U-shaped frame 11 and the second U-shaped frame 12 are both provided with two U-shaped plug posts 17, and the two U-shaped plug posts 17 form a closed ring structure together with the supporting rods 16. A bottom of the seat pan 23 is provided with two inserting rods 25 along a width direction thereof, and an end portion of the inserting rod 25 is provided with a groove 251. When the seat pan 23 gradually rotates to a horizontal state, the inserting rod 25 moves toward the plug post 17 until part of the end portion of the inserting rod 25 enters into the annular structure. At this time, the plug post 17 is also inserted into the groove 251 and abutted against the inner wall of the groove 251, thereby limiting the position of the seat 2 on the cart body 1.

It should be noted that the supporting rods 16 provided on the first U-shaped frame 11 and the second U-shaped frame 12 are both provided with a plug post 17, which is convenient to set the position of the seat 2 according to actual requirements. The number of the plug posts 17 is not limited to be two, and may be increased in order to improve the connection stability. Of course, the production cost will also increase correspondingly, so it can be provided according to actual needs.

In addition, a further improvement of this embodiment is that an inserting hole 31 for placing the transfusion rod 6 is arranged on one first upright pole 111 and an inserting hole 31 for placing the transfusion rod 6 is arranged on one second upright pole 121. Referring to FIG. 3, in this embodiment, a first buckle 3 is provided on the rear-side second upright pole 121 along its height direction, and an inserting hole 31 capable of accommodating the transfusion rod 6 is formed on the first buckle 3, so that the transfusion rod 6 can be inserted into the inserting hole 31 and moved with the cart, thereby reducing waste of manpower. It can be understood that, in this embodiment, the first buckle 3 may further be arranged on the front-side second upright pole 121, the first buckles 3 may further be arranged on two first upright poles 111, or the structure of the first buckle 3 may be arranged on one of the first upright poles 111 and one of the second upright poles 121 at the same time.

Meanwhile, as another improvement, one of the first upright poles 111 is provided with a through hole 41 for mounting an oxygen cylinder erecting bracket 7, and one of the second upright poles 121 is provided with a through hole 41 for mounting an oxygen cylinder erecting bracket 7. Referring to FIGS. 1 and 3, another fixing structure is arranged on the front-side second upright pole 121 along its height direction, which can further be provided as a second buckle 4 identical or similar to the above-mentioned first buckle 3. The through hole 41 for mounting the oxygen cylinder erecting bracket 7 is formed on the second buckle 4, so that the oxygen cylinder can move with the cart, thus meeting specific medical needs.

In this embodiment, as a further improvement, a first strut 181 for preventing falling is arranged between the first upright pole 111 and the second upright pole 121, which are arranged on the same side along the length direction of the cart, and a second strut 182 for preventing falling is arranged between the two first upright poles 111 and the two second upright poles 121. Still referring to FIGS. 2 and 4, bent first struts 181 are inserted in both front and rear sides of the cart, and bent second struts 182 are inserted in both left and right sides of the cart, so as to increase the height of four sides of the cart and prevent children from falling out of the cart.

The children's medical cart with a seat according to this embodiment is provided with a foldable seat 2 and detachably connected with the cart body 1 through the cooperation between the connecting part and the connection fitting part, so as to meet the use requirements of two environments, namely, when a child needs to use the seat 2 for a long time, the seat 2 can be set on the cart for a long time and can be folded with the cart for storage; when the seat 2 is not needed, the seat 2 can be detached from the cart to enlarge the accommodation space of the cart.

In addition, the plug-in part and the plug-in fitting part are designed to ensure stability of the seat 2 in a use state, thereby improving safety of the entire medical cart. Moreover, the cart is designed with an inserting hole 31 and a through hole 41 for mounting the transfusion rod 6 and the oxygen cylinder, as well as the first strut 181 for preventing falling, the second strut 182 and the reinforcing rod 19, enhancing its function as a carrier of medical equipment. When designing, the versatility, portability and safety of the medical cart are taken into account to accommodate children's mobility and treatment needs in a healthcare environment.

The children's medical cart with a seat according to this embodiment, wherein when folded, the second U-shaped frame 12 moves upward, and the hinged position of the middle part of the first folding bar 151 and the second folding bar 152 rotates, while driving the second U-shaped frame 12 to move upward. At this time, the end portions of the first connecting rod 141 and the second connecting rod 142 connected with the bottom of the second U-shaped frame 12 move upward accordingly, and at the same time, the other end portions of the first connecting rod 141 and the second connecting rod 142 approach each other, the first U-shaped frame 11 and the second U-shaped frame 12 are brought to approach each other, and a folding process is performed.

The above description is only the preferred embodiments of this embodiment, and does not limit this embodiment. Any modifications, equivalent substitutions, improvements, etc. made within the spirit and principle of this embodiment shall be covered by the protection scope of this embodiment.

What is claimed is:

1. A children's medical cart with a seat, comprising a cart body (1) and a seat (2) arranged on the cart body (1);
wherein the seat (2) comprises a seat pan (23) and a back pan (21), the seat pan (23) is hinged with the back pan (21); the seat (2) has a first state folded and a second state unfolded; in the first state, the seat pan (23) is parallel to the back pan (21), and in the second state, the seat pan (23) and the back pan (21) are turned over at a certain angle;
the back pan (21) is provided with a connecting part for connecting with the cart body (1), and both sides along a length direction of the cart body (1) are each provided with a connection fitting part for connecting with the seat (2); the connecting part is connected with one of the connection fitting parts so as to mount the seat (2) on the cart body (1); and
the seat pan (23) is provided with a plug-in part extending along one of its sides facing the back pan (21), and both sides along the length direction of the cart body (1) are each provided with a plug-in fitting part corresponding to the plug-in part; in the second state, the plug-in part is inserted into one of the plug-in fitting parts so as to restrain the seat pan (23) on the cart body (1).

2. The children's medical cart with a seat according to claim 1, wherein
the connection fitting part is a supporting rod (16) horizontally arranged in a width direction of the cart body (1); and
the connecting part is a joint bar (22) arranged on the back pan (21), the joint bar (22) extends along a height direction of the back pan (21), and the joint bar (22) and the back pan (21) are arranged perpendicular to each other; one side of the joint bar (22) is fixedly connected with the back pan (21) and the other side is provided with a hooking part (221), and the hooking part (221) is hooked with the supporting rod (16).

3. The children's medical cart with a seat according to claim 2, wherein
a lower end of the joint bar (22) extends towards the seat pan (23), and limits a rotation angle of the seat pan (23) relative to the joint bar (22) by a limiting part; and
the seat pan (23) is detachably provided with an elastic air cushion (231).

4. The children's medical cart with a seat according to claim 3, wherein
the limiting part comprises an arc-shaped sliding slot (222) arranged on the joint bar (22), and a sliding rod (241) arranged on the seat pan (23); when the sliding rod (241) slides along a lower end of the arc-shaped sliding slot (222) to an upper end thereof, the seat (2) is switched from the first state to the second state.

5. The children's medical cart with a seat according to claim 1, wherein
the plug-in part comprises an inserting rod (25) arranged on the seat (2), the inserting rod (25) extends towards the back pan (21), and a groove (251) is provided at an end of the inserting rod (25); and
the plug-in fitting part comprises a plug post (17) arranged on the cart body (1); in the second state, the plug post (17) abuts in the groove (251) to clamp the seat pan (23) on the cart body (1).

6. The children's medical cart with a seat according to claim 1, wherein
the cart body (1) comprises a first U-shaped frame (11) and a second U-shaped frame (12) arranged symmetrically along a width direction of the cart, and a third U-shaped frame (13) arranged between the first U-shaped frame (11) and the second U-shaped frame (12); a push rod (110) is hingedly arranged between two top ends of the first U-shaped frame (11) and the second U-shaped frame (12), wheels (5) are arranged at a bottom of two folding corners of the first U-shaped frame (11) and the second U-shaped frame (12), two folding corners of the third U-shaped frame (13) are hinged with two folding corners of the first U-shaped frame (11) through two first connecting rods (141), and two folding corners of the third U-shaped frame (13) are hinged with two folding corners of the second U-shaped frame (12) through two second connecting rods (142);
the first U-shaped frame (11) comprises two first upright poles (111) symmetrically arranged along a length direction of the cart, and a first cross bar (112) connecting the two first upright poles (111); the second U-shaped frame (12) comprises two second upright poles (121) symmetrically arranged along a length direction of the cart, and a second cross bar (122) connecting the two second upright poles (121); the third U-shaped frame (13) comprises two third upright poles (131) symmetrically arranged along a length direction of the cart, and a third cross bar (132) connecting the two third upright poles (131); and
a top end of the first upright pole (111) is hinged with a bottom end of the second upright pole (121) arranged on the same side along a length direction of the cart through a first folding bar (151), and a bottom end of the first upright pole (111) is hinged with a top end of the second upright pole (121) arranged on the same side along a length direction of the cart through a second folding bar (152), and both the first folding bar (151) and the second folding bar (152) are hinged with a top of the third upright pole (131) on the same side.

7. The children's medical cart with a seat according to claim 6, wherein
one of the first upright poles (111) is provided with an inserting hole (31) for placing a transfusion rod (6), and/or one of the second upright poles (121) is provided with an inserting hole (31) for placing a transfusion rod (6).

8. The children's medical cart with a seat according to claim 6, wherein
one of the first upright poles (111) is provided with a through hole (41) for mounting an oxygen cylinder erecting bracket (7), and/or one of the second upright poles (121) is provided with a through hole (41) for mounting an oxygen cylinder erecting bracket (7).

9. The children's medical cart with a seat according to claim 6, wherein
a first strut (181) for preventing falling is arranged between the first upright pole (111) and the second upright pole (121), which are arranged on the same side along the length direction of the cart, and a second strut (182) for preventing falling is arranged between the two first upright poles (111) and the two second upright poles (121).

10. The children's medical cart with a seat according to claim 6, wherein
a plurality of reinforcing rods (19) are respectively arranged between the two first connecting rods (141) and the second connecting rods (142) arranged on the same side in a width direction of the cart.
